(19) United States
(12) Patent Application Publication
(10) Pub. No.: US 2007/0168146 A1
(43) Pub. Date: Jul. 19, 2007

(54) Method for calibrating a device, method for calibrating a number of devices lying side by side as well as an object suitable for implementing such a method

(75) Inventors: Joseph L. Horijon, Veldhoven (NL); Alain De Bock, Veldhoven (NL); Rita M.A.L. Petit, Veldhoven (NL)

Correspondence Address: FOLEY AND LARDNER LLP;SUITE 500, 3000 K STREET NW, WASHINGTON, DC, 20007, US

(73) Assignee: Assembleon N.V.

(21) Appl. No.: 10/550,269

(22) PCT Filed: Mar. 19, 2004
(86) PCT No.: PCT/IB04/50294

§ 371 Date: Nov. 6, 2006

(30) Foreign Application Priority Data
Mar. 26, 2003 (EP) 03075867.6

(51) Int. Cl. G06F 19/00; G03B 3/00; G03B 13/22; G01C 17/38; G01P 21/00

(52) U.S. Cl. 702/94

(57) ABSTRACT

A method for calibrating at least one device (2) that comprises a camera, in which an object (3, 10) having at least one reference element (4, 11, 12, 13, 14) is brought into the image area of the camera. A first position of the reference element (4, 11, 12, 13, 14) relative to the device (2) is determined from an image (5, 6, 8, 9, 15, 16) made by the camera. Then a displacem relative to the device (2) is imposed on the object (3, 10). A second position of the reference element (4, 11, 12, 13, 14) relative to the device (2) is determined from a second image made by the camera (5, 6, 8, 9, 15, 16). A real displacement of the object (3, 10)(3) relative to the device (2) is determined from the first and second relative positions, which real displacement is compared with the imposed displacement.

The invention relates to a method for calibrating at least one device that comprises a camera.

The invention also relates to a method for calibrating a number of devices positioned side by side, which each comprise a camera.

The invention further relates to an object suitable to be applied to such methods.

It is known per se to place components onto a substrate with a device. At least a portion of the substrate is perceived by means of a camera belonging to the machine, after which the device is driven such that a component can be positioned on the substrate on a desired position.

Then the substrate is moved relative to the device, after which again a component is positioned on the substrate. Once an initial position of the substrate relative to the device has been established by means of the camera, the substrate is then moved to any desired position relative to the device by a drive. If the substrate is moved relative to the device it is important to be sure that this imposed displacement is also really executed. For this purpose the device is to be calibrated.

It is an object of the invention to provide a method with which the device can be calibrated in a simple manner.

This object is achieved with the method according to the invention in that an object having at least one reference element is brought into an image area of the camera, after which a first position of the reference element relative to the device is determined from an image made by the camera, then a displacement relative to the device is imposed on the object, a second position of the reference element relative to the device is determined from a second image made by the camera, after which a real displacement of the object relative to the device is determined from the first and second relative positions, which real displacement is compared with the imposed displacement.

If the real displacement corresponds to the imposed displacement and when subsequently the device is used for, for example, placing components onto a substrate, it may be assumed when the substrate is displaced, that this substrate really undergoes this desired displacement.

If the real displacement does not correspond to the imposed displacement, there should be examined what has caused this deviation and the device can be adapted as required. Alternatively, however, it is possible to adapt the imposed displacement on the basis of the differences perceived between the real displacement and the imposed displacement so that a desired real displacement is realized as yet.

The method is suitable for a single device or a number of devices erected side by side which each comprise a camera.

When a number of devices are used which are located side by side calibration can take place separately for each device. If a substrate is simultaneously provided with components by means of a number of devices, it is, however, also important for the interdependent positions of the devices to be taken into account.

Therefore, the invention has for an object to provide a method in which a number of devices installed side by side can be calibrated relative to one another in a relatively simple and accurate way.

The reference elements on the object have a fixed mutual position. By taking a number of images of the object by means of a number of cameras, with at least one reference element being perceivable in each image, the relative position of the reference element concerned relative to the device can now be determined from each image. Since the mutual positions of the reference elements on the object are known or can be determined, the mutual positions of the devices can be derived from the available information.

An embodiment of the method according to the invention is characterized in that the object comprises at least four reference elements whose mutual positions are known, at least two reference elements being perceived while an image is being made by means of the camera

Based on the position of at least two reference elements as well as the mutual positions of the reference elements, the orientation of the reference-element-carrying object relative to the device can be established in a simple manner. For calibrating a single device, it is possible for example first to perceive all four reference elements, whereas not more than two reference elements are perceived once a displacement has occurred. Thus it is possible to perform an accurate calibration of the displacement carried out by means of the device.

If at least two adjacent devices have to be calibrated, for example first an image can be produced by means of a camera of a first device, while all reference elements are perceivable in the image. Then the object is displaced to a position where two reference elements are perceived by means of the first camera while at the same time the other reference elements are perceived by means of a camera of a device located next to it.

Since the mutual positions of the reference elements relative to each other can be determined from the image produced first, the mutual positions of the devices relative to each other can be simply derived from the images produced subsequently of two reference elements each.

Yet a further embodiment of the method according to the invention is characterized in that the positions of the reference elements relative to each other can be determined from an image produced by the camera.

In this way the mutual position of the reference elements relative to each other is determined by means of the camera located on the device. Thus these mutual positions need not be determined in advance. The advantage of this is that if the object has shrunk or expanded owing to temperature variations, this does not affect the accuracy of the calibration method because the mutual positions of the reference elements are determined just before the device is calibrated.

It is also an object of the invention to provide an object with which a device can be calibrated in a simple fashion.

For the object according to the invention this object is achieved in that the object comprises a number of reference elements.

In this way it is possible to apply an object that accommodates clearly perceivable reference elements, which can be detected relatively well by means of a camera and whose mutual positions can be accurately determined from an image produced by means of the camera. The object may be the substrate on which components are to be mounted or a product specifically made for the purpose of calibration.

One embodiment of the object according to the invention is characterized in that the object is a plate on which a number of marking elements serving as reference elements are introduced.

Such an object with a relatively large number of reference elements can be manufactured in a simple way and is suitable to perceive by means of a number of cameras, which are installed on a number of devices arranged in a side-by-side array. Furthermore, by means of such an object the mutual positions of the devices can be established in a relatively accurate and fast manner.

The invention will be further explained with reference to the drawings in which:

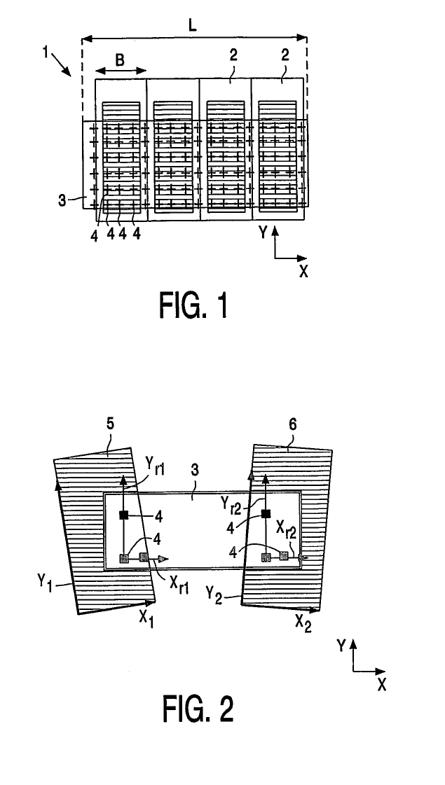

FIG. 1 shows a plan view of a number of devices placed side by side and an object with reference elements, which is positioned therein

FIG. 2 shows images made by two devices side by side,

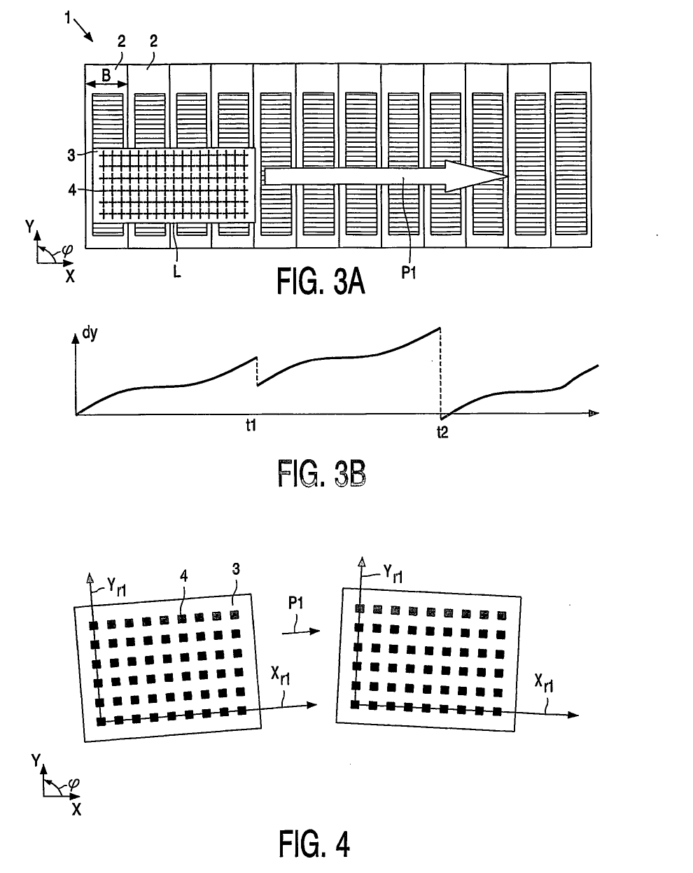

FIG. 3A shows a number of devices placed side by side as well as an object moving through the devices,

FIG. 3B shows a graph in which are plotted deviations in Y-direction during the displacement of the object through the devices,

FIG. 4 shows two images of an object made before and after a displacement, and

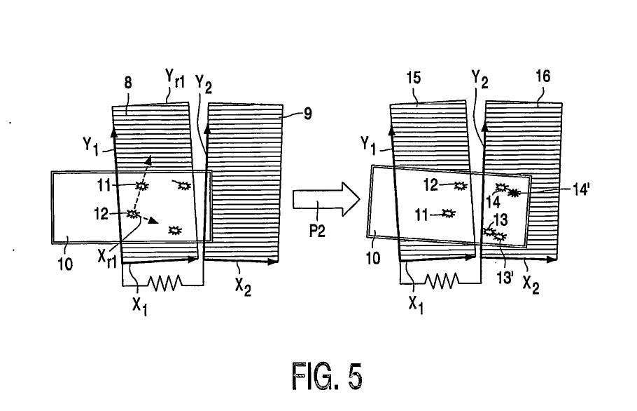

FIG. 5 shows images of an object in two different positions relative to two devices.

Like elements in the Figures have like reference numerals.

FIG. 1 shows a component placement machine 1 comprising a number of devices 2 positioned side by side. Each device 2 comprises a camera as well as a placement unit by means of which components can be placed on a substrate. Such devices are known per se and will therefore not be explained any further. The component placement device 1 accommodates a disk-like object 3 on which a large number of reference elements 4 are provided in a grid. These reference elements may be crosses, dots, blocks etc. As appears from FIG. 1 the length L of the object 3 is longer in a direction shown by the arrow X than the width B of a single device 2. As a result, the object 3 lies in a number of devices 2 and can be perceived in each device 2 by means of an associated camera.

Now if the positions of the separate reference elements 4 relative to each other are known or are determined, the positions of the devices 2 relative to each other can be established in a simple manner.

FIG. 2 shows two coordinate systems X1-Y1 and X2-Y2, which belong to two different devices 2. In the situation shown in FIG. 2 the axis X1 encloses a different angle to the axis X than to the axis X2. Therefore, a position in the X1-Y1 coordinate system cannot be transferred to the coordinate system X2-Y2 just like that.

To calibrate the two coordinate systems X1-Y1 and X2-Y2 respectively relative to each other which belong to devices 2, that is to say to establish the mutual relation, an image 5, 6 is made by means of the camera belonging to the device concerned. From the image 5, 6 are determined the relative positions of the reference elements 4 present in the image 5, 6 relative to the coordinate system X1-Y1 and X2-Y2 respectively. The reference elements 4 present in the image 5 are situated in a coordinate system Xr1-Yr2 relative to the object 3, whereas the marking elements 4 present in the image 6 are situated in a coordinate system Xr2-Yr2 relative to the object 3. The positions of the coordinate systems Xr1-Yr1 and Xr2-Yr2 relative to each other are known per se, for example because the mutual positions are measured prior to the placement of the object 3 in the machine 1. The position of the coordinate system X1-Y1 relative to the coordinate system X2-Y2 can be determined from the positions of the reference elements relative to the coordinate systems X1-Y1 and X2-Y2 as well as the mutual positions known per se between the reference elements present in the image 5 and the reference elements present in the image 6. In this respect use is made of techniques known for example from robotics such as homogeneous coordinates transformation. In the situation shown in FIG. 2 only two images 5, 6 are shown. In the component placement machine 1 as shown in FIG. 1 an image of the object 3 is simultaneously made by the camera belonging to each device 2, so that four images are obtained. The mutual positions of the coordinate systems belonging to each device 2 can be derived from these four images. The position and orientation of each coordinate system relative to the X-Y coordinate system can be determined or the positions of the coordinate systems can be related to a coordinate system, for example, X1-Y1, belonging to a device 2.

FIG. 3A shows a plan view of a component placement machine 1 which comprises twelve devices 2 placed side by side. The length L of the object 3 is larger than the width B of a single device 2, but smaller than the total width 12B of the component placement machine 1. The object 3 is transported through the component placement machine 1 by means of a transport device (not shown) in the direction indicated by the arrow P1, where the object 3 is always located in a number of devices 2 and is therefore always perceived by a number of cameras belonging to the devices 2. In the same way as described with reference to FIG. 1 and FIG. 2, the relative mutual positions and orientations of the coordinate systems belonging to each device 2 can be calculated. In addition, it is possible to check the accuracy with which the transport device transports the object 3 in the direction shown by arrow P1 by means of the images obtained. If both before and after the object 3 has been moved in the direction shown by arrow P1 an image is made by means of a camera belonging to device 2, it is possible to establish from this image the displacement that has really been effected. If the transport device functions properly, the object 3 will only have performed a displacement in X direction over a desired predefined distance and no displacement in the Y direction will have taken place. However, owing to inaccuracies in the transport device, there may nevertheless be relatively small deviations of the order of 10 Fm in X direction, 100 Fm in Y direction and 0.05 mrad in φ direction. The deviations dy in Y direction are plotted in the graph shown in FIG. 3B, where the deviation dy is a function of the position of the transport device. The deviations in X and φ direction can be determined in similar manner. At times t1 and t2 the displacement of the object 3 in the direction shown by arrow P1 is taken over by another portion of the transport device which comprises for example a beam of clamping elements moving in a step by step manner. This beam is moved back from a right hand end position to the left hand end position in a single move. The substrates are then temporarily supported by the clamping elements. A transport device of this type is known per se and will not be further explained in detail. More importantly, with the method according to the invention can be determined the deviations that are caused by the transport device.

Based on the information thus obtained it is possible to reckon with the deviation in X, Y and φ direction when the components are placed on a substrate by means of the device 2, which direction the substrate will have relative to an expected position, so that the component can yet be placed on the desired position on the substrate while these deviations are taken into account.

FIG. 4 shows two images of an object 3 with reference elements 4 present thereon, where the images are made before and after respectively a displacement in a direction shown by arrow P1. The images are composed of the various images made by the cameras belonging to the devices 2. From the images shown in FIG. 4 there may clearly be seen that the substrate as a result of the displacement P1 intended in the pure X direction also undergoes a displacement in Y direction and a rotation in (P direction. It is alternatively possible for the distance between the reference elements in the images to differ from the real distance.

In the images represented in FIGS. 1-4 a disk-like object 3 is used which accommodates a number of reference elements 4 in a grid. The disk-like object 3 may be for example a glass disk. The disk-like object 3 is specifically made for calibrating the devices and comprises a relatively large number of clearly perceivable reference elements.

Alternatively, however, it is possible to calibrate with a substrate on which components are to be placed.

In the situation shown in FIG. 5 images 8, 9 have been made by means of cameras belonging to devices 2. The images 8, 9 show a substrate 10 on which a number of components 11, 12, 13, 14 acting as reference elements are present. These elements 11-14 may be for example components placed on the substrate 10, electrically conductive tracks present on the substrate etc. From the image 8 are derived the mutual positions of the elements 11-14 relative to a coordinate system Xr1-Yr1 defined by the elements 11-12. Also the positions of the elements 11-14 are calculated relative to a coordinate system X1-Y1 belonging to the device 2. The positions of the elements 11-14 cannot be determined from the image 9.

Then the substrate 10 is moved in a direction shown by the arrow P2. In this position of the substrate 10 images 15, 16 are made by the same devices 2 that have made images 8, 9. The substrate 10 is moved such that now two elements 11, 12 serving as reference elements are perceivable in the image 15 and two elements 13, 14 serving as reference elements are perceivable in the image 16. The positions of the elements 11, 12 are again determined relative to the coordinate system X1-Y1. From the position of the elements 11, 12 in image 8 and image 15 respectively, the real displacement of the substrate 10 can be determined. From the image 16 are calculated the positions of the elements 13, 14 relative to a coordinate system X2-Y2 belonging to the image 16. Since the positions of the elements 13, 14 relative to the elements 11, 12 have not been changed and have been determined from image 8, it is subsequently possible to determine the position of the coordinate system X2-Y2 relative to the coordinate system X1-Y1 from the available information. If the position of the coordinate system X2-Y2 were located at an expected position relative to the coordinate system X1-Y1, the reference elements 13, 14 would be located on the positions 13′, 14′ relative to the expected coordinate system. From the mutual positions of the reference elements 13, 14 and 13′, 14′ can be determined the real position of the coordinate system X2-Y2 relative to the expected location of the coordinate system X2 -Y2 relative to the coordinate system X1-Y1.

It is alternatively possible to regard more than four elements as reference elements, thus enhancing accuracy.

1. A method for calibrating at least one device (2) that comprises a camera, characterized in that an object (3, 10) having at least one reference element (4, 11, 12, 13, 14) is brought into an image area of the camera, after which a first position of the reference element (4, 11, 12, 13, 14) relative to the device (2) is determined from an image (5, 6, 8, 9, 15, 16) made by the camera, then a displacement relative to the device (2) is imposed on the object (3, 10), a second position of the reference element (4, 11, 12, 13, 14) relative to the device (2) is determined from a second image made by the camera (5, 6, 8, 9, 15, 16), after which a real displacement of the object (3, 10)(3) relative to the device (2) is determined from the first and second relative positions, which real displacement is compared with the imposed displacement.

2. A method for calibrating a number of devices (2) positioned side by side which each comprise a camera, characterized in that anobject (3, 10) having reference elements (4, 11, 12, 13, 14) is brought into an image area of at least two cameras of at least two devices (2), after which first positions of at least one reference element (4, 11, 12) are determined relative to a first device (2), second positions of at least one reference element (4, 13, 14) are determined relative to the second device (2), after which the position of the second device (2) relative to the first device (2) is determined from the first and second relative positions of the reference elements (4, 11, 12, 13, 14)

3. A method according to claim 1, characterized in that the object (3, 10) has at least four reference elements (4, 11, 12, 13, 14) whose positions relative to each other are known while at least two reference elements (4, 11, 12, 13, 14) are perceived during the making of an image (5, 6, 8, 9, 15, 16) by means of the camera.

4. A method according to claim 1, characterized in that the positions of the reference elements (4, 11, 12, 13, 14) relative to each other are determined from an image (5, 6, 8, 9, 15, 16) made by means of the camera.

5. An object (3, 10) suitable for implementing the method as claimed in any one of the preceding claims according to claim 1, characterized in that the object (3, 10) has a number of reference elements (4, 11, 12, 13, 14).

6. An object (3, 10) as claimed in claim 5, characterized in that the object (3, 10) is a plate on which a number of marking elements serving as reference elements (4, 11, 12, 13, 14) are provided in a grid pattern

7. A method as claimed in claim 2, characterized in that the object (3, 10) has at least four reference elements (4, 11, 12, 13, 14) whose positions relative to each other are known while at least two reference elements (4, 11, 12, 13, 14) are perceived during the making of an image (5, 6, 8, 9, 15, 16) by means of the camera.

8. A method as claimed in claim 2, characterized in that the positions of the reference elements (4, 11, 12, 13, 14) relative to each other are determined from an image (5, 6, 8, 9, 15, 16) made by means of the camera.

9. An object (3, 10) suitable for implementing the method as claim in claim 2, characterized in that the object (3, 10) has a number of reference elements (4, 11, 12, 13, 14).

10. An object (3, 10) as claimed in claim 9, characterized in that the object (3, 10) is a plate on which a number of marking elements serving as reference elements (4, 11, 12, 13, 14) are provided in a grid pattern
